(19) United States
(12) Patent Application Publication
(10) Pub. No.: US 2025/0119790 A1
(43) Pub. Date: Apr. 10, 2025

(54) COMMUNICATION APPARATUS, COMMUNICATION METHOD, AND STORAGE MEDIUM

(71) Applicant: CANON KABUSHIKI KAISHA, Tokyo (JP)

(72) Inventor: MITSUYOSHI YUKAWA, Kanagawa (JP)

(21) Appl. No.: 18/922,857

(22) Filed: Oct. 22, 2024

Related U.S. Application Data
(63) Continuation of application No. PCT/JP2023/014609, filed on Apr. 10, 2023.

(30) Foreign Application Priority Data
Apr. 25, 2022 (JP) 2022-071972

(51) Int. Cl. H04W 28/06; H04L 5/00; H04W 72/0446

(52) U.S. Cl. CPC H04W 28/06; H04L 5/0048; H04W 72/0446

(57) ABSTRACT

A wireless communication apparatus includes communicating means configured to communicate an IEEE 802.11-compliant MAC frame. The MAC frame includes a Type field indicating that the type of the MAC frame is a control frame, and a Subtype field indicating that a Control Frame Extension field is included. In a case where a value indicating existence of a predetermined field, in which a value indicating a type of the control frame is settable and which is different both from the Subtype field and from the Control Frame Extension field, is set in the Control Frame Extension field, the MAC frame further includes the predetermined field.

### CROSS-REFERENCE TO RELATED APPLICATIONS

This application is a Continuation of International Patent Application No. PCT/JP2023/014609, filed Apr. 10, 2023, which claims the benefit of Japanese Patent Application No. 2022-071972, filed Apr. 25, 2022, both of which are hereby incorporated by reference herein in their entirety.

### TECHNICAL FIELD

The present disclosure relates to a frame transmitted and received via wireless communication.

### BACKGROUND ART

In recent years, to cope with an increase in an amount of data communicated between communication apparatuses, the development of communication technology such as wireless LAN (Local Area Network) has been advancing. IEEE (Institute of Electrical and Electronics Engineers) 802.11 series standards are known as major communication standards for wireless LAN. The IEEE 802.11 series standards include IEEE 802.11a/b/g/n/ac/ax, etc. For example, in IEEE 802.11ax, OFDMA technology, and technology for improving communication efficiency in a situation of being congested with wireless communication apparatuses (see PTL 1), have been standardized to realize a high peak throughput of maximum 9.6 gigabits per second (Gbps). OFDMA means, and is an acronym for, Orthogonal Frequency Division Multiple Access. Besides it, efficient communication technology based on multi-user uplink communication using a control frame called a trigger frame has been adopted. By an access point (AP) transmitting a trigger frame to a station (STA), uplink communication from the STA to the AP is controlled.

Aiming for further improving a throughput, improving frequency use efficiency, and improving communication latency, a task group of a successor standard called IEEE 802.11be was set up. In the IEEE 802.11be standard, for example, Multi-Link communication, in which a single AP establishes a plurality of links to communicate with a single STA via a plurality of different frequency channels, has been being studied. Besides it, as technology for improving a throughput, new technology for extending the maximum frequency bandwidth of a radio wave to 320 MHz has been being studied.

With the development of communication technology for wireless LAN, new formats are defined for a MAC (Medium Access Control) frame having various functions. A MAC frame for wireless LAN is constructed of a plurality of fields. One of the plurality of fields is a Frame Control field, which includes information for identifying the type of the MAC frame. More specifically, the type of the MAC frame is identifiable by a combination of information in a Type subfield and information in a Subtype subfield that are included in the Frame Control field. A MAC frame is categorized into four types, which are: a management frame, a control frame, a data frame, and an extension frame, and they are identifiable by the value of the Type subfield.

### CITATION LIST

### Patent Literature

PTL 1: Japanese Patent Laid-Open No. 2018-50133

As described above, the type of a MAC frame for wireless communication conforming to the IEEE 802.11 standard is identifiable on the basis of information included in the Frame Control field.

As the development of communication technology for wireless LAN progresses, various kinds of frame are defined anew. Among others, for a MAC frame belonging to a kind called “control frame”, types the number of which is greater than those identifiable by an information amount of four bits assigned to the Subtype subfield have already been defined. For a solution to this, a Control Frame Extension subfield, to which four bits different from those assigned to the Subtype subfield are assigned, is available. In a case where the Control Frame Extension subfield is used, the existence of the Control Frame Extension subfield is indicated by setting a particular value in the Subtype subfield.

However, it is expected that the types of a control frame will continue to increase in the future. However, when the number of them reaches the upper limit of the number of types identifiable by means of the existing Subtype subfield and the existing Control Frame Extension subfield, it will become impossible to define any more new type of a control frame.

### SUMMARY OF THE INVENTION

An object of the present disclosure, in view of the above issue, is to make it possible to communicate a MAC frame well when wireless communication conforming to the IEEE 802.11 standard is performed.

To achieve the above object, a wireless communication apparatus according to the present disclosure includes: transmitting means configured to transmit a MAC frame conforming to an IEEE 802.11 standard, wherein the MAC frame includes a Frame Control field, the Frame Control field includes a Type field indicating a type of the MAC frame, the Frame Control field further includes a Subtype field in a case where a value indicating that the type of the MAC frame is a control frame is set in the Type field, the Frame Control field further includes a Control Frame Extension field in a case where a value indicating existence of the Control Frame Extension field is set in the Subtype field, and the MAC frame further includes a predetermined field in a case where a value indicating existence of the predetermined field is set in the Control Frame Extension field, the predetermined field being a field in which a value indicating a type of the control frame is settable and which is different both from the Subtype field and from the Control Frame Extension field. A wireless communication apparatus according to the present disclosure includes: transmitting means configured to transmit a MAC frame conforming to an IEEE 802.11 standard, wherein the MAC frame includes a Frame Control field, the Frame Control field includes a Type field indicating a type of the MAC frame, the Frame Control field further includes a Subtype field in a case where a value indicating that the type of the MAC frame is a control frame is set in the Type field, the Frame Control field further includes a Control Frame Extension field in a case where a value indicating existence of the Control Frame Extension field is set in the Subtype field, and the MAC frame further includes a predetermined field in a case where a value indicating existence of the predetermined field is set in the Subtype field, the predetermined field being a field in which a value indicating a type of the control frame is settable and which is different both from the Subtype field and from the Control Frame Extension field.

A wireless communication apparatus according to the present disclosure includes: receiving means configured to receive a MAC frame conforming to an IEEE 802.11 standard, wherein the MAC frame includes a Frame Control field, the Frame Control field includes a Type field indicating a type of the MAC frame, the Frame Control field further includes a Subtype field in a case where a value indicating that the type of the MAC frame is a control frame is set in the Type field, the Frame Control field further includes a Control Frame Extension field in a case where a value indicating existence of the Control Frame Extension field is set in the Subtype field, and the MAC frame further includes a predetermined field in a case where a value indicating existence of the predetermined field is set in the Control Frame Extension field, the predetermined field being a field in which a value indicating a type of the control frame is settable and which is different both from the Subtype field and from the Control Frame Extension field.

A wireless communication apparatus according to the present disclosure includes: receiving means configured to receive a MAC frame conforming to an IEEE 802.11 standard, wherein the MAC frame includes a Frame Control field, the Frame Control field includes a Type field indicating a type of the MAC frame, the Frame Control field further includes a Subtype field in a case where a value indicating that the type of the MAC frame is a control frame is set in the Type field, the Frame Control field further includes a Control Frame Extension field in a case where a value indicating existence of the Control Frame Extension field is set in the Subtype field, and the MAC frame further includes a predetermined field in a case where a value indicating existence of the predetermined field is set in the Subtype field, the predetermined field being a field in which a value indicating a type of the control frame is settable and which is different both from the Subtype field and from the Control Frame Extension field.

Further features of the present invention will become apparent from the following description of exemplary embodiments with reference to the attached drawings.

### BRIEF DESCRIPTION OF DRAWINGS

FIG. 1 is a diagram illustrating an example of the configuration of a wireless communication system according to an embodiment.

FIG. 2 is a diagram illustrating an example of the hardware configuration of a communication apparatus according to an embodiment.

FIG. 3 is a diagram illustrating an example of the functional configuration of a communication apparatus according to an embodiment.

FIG. 4 is a diagram illustrating a frame format used in a first embodiment.

FIG. 5 is a diagram illustrating values that are settable in a Subtype subfield according to the first embodiment.

FIG. 6 is a diagram illustrating values that are settable in a Control Frame Extension subfield according to the first embodiment.

FIG. 7 is a diagram illustrating a frame format used in a second embodiment.

FIG. 8 is a diagram illustrating a frame format used in a third embodiment.

FIG. 9 is a diagram illustrating values that are settable in a Subtype subfield according to the third embodiment.

FIG. 10 is a diagram illustrating a frame format used in a fourth embodiment.

### DESCRIPTION OF EMBODIMENTS

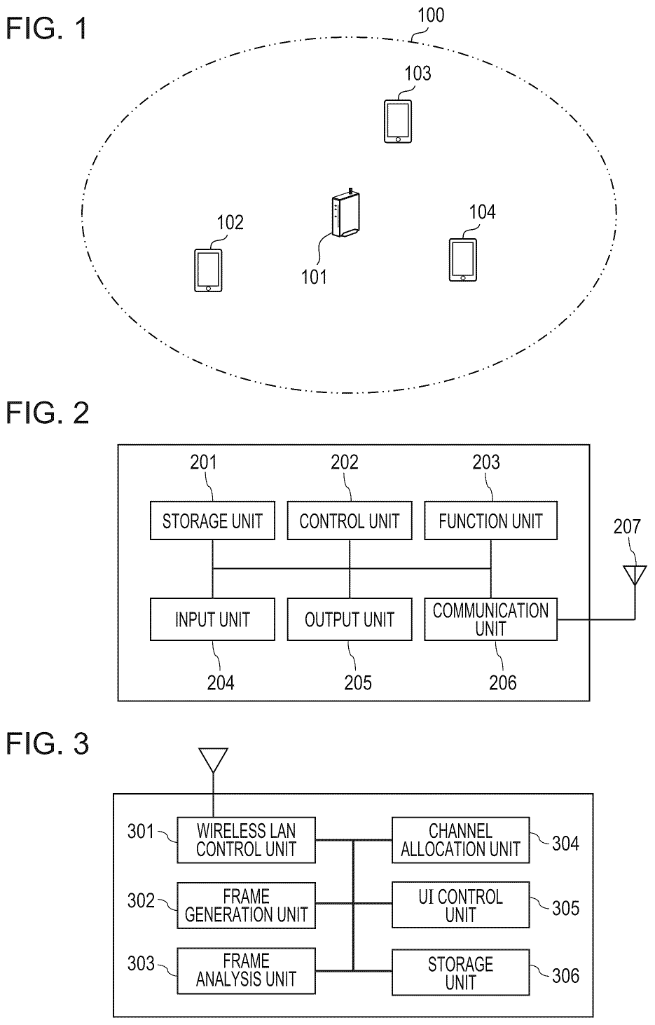

FIG. 1 is a diagram illustrating an example of the configuration of a network according to the present embodiment. A communication apparatus 101 is an AP (access point) that has a role of establishing a wireless network 100. Communication apparatuses 102 to 104 are STAs (stations) that participate in the wireless network 100. The communication apparatus 101 is capable of communicating with the communication apparatuses 102 to 104.

Each of the communication apparatuses 101 to 104 is capable of performing wireless communication conforming to the IEEE 802.11 standard. IEEE is an acronym for Institute of Electrical and Electronics Engineers. The IEEE 802.11 standard includes IEEE 802.11 series standards such as IEEE 802.11a/b/g/n/ac/ax/be standards.

The communication apparatuses 101 to 104 may be any kind of communication apparatus supporting the IEEE 802.11 standard. That is, it is sufficient as long as the communication apparatus has a function of transmitting and receiving a MAC frame in which the Protocol Version subfield in the Frame Control field is 0. In addition to the IEEE 802.11 standard, the communication apparatus may support any other communication standard such as Bluetooth®, NFC, UWB, ZigBee, MBOA, or the like. UWB is an acronym for Ultra Wide Band. MBOA is an acronym for Multi Band OFDM Alliance. NFC is an acronym for Near Field Communication. UWB includes wireless USB, wireless 1394, WiNET, and the like. The communication apparatus may support any communication standard for wired communication such as wired LAN.

Some specific examples of the communication apparatuses 101 to 104 are: wireless LAN router, personal computer (PC), etc., without any limitation thereto. The communication apparatus 101 to 104 may be an information processing apparatus such as a wireless chip capable of performing wireless communication conforming to the IEEE 802.11 standard. Another specific example of the communication apparatuses 101 to 104 is: IoT device such as camera, printer, tablet, smartphone, mobile phone, video camera, smart home appliance, or the like, without any limitation thereto. Though the wireless network illustrated in FIG. 1 is made up of one AP and three STAs, the number of APs and the number of STAs are not limited to this example. Configuration of AP and STA

An example of the hardware configuration of the communication apparatus 101, which is an AP in the present embodiment, is illustrated in FIG. 2. The same or similar configuration can also be adopted for the communication apparatuses 102 to 104, which are STAs. The communication apparatus 101 includes a storage unit 201, a control unit 202, a function unit 203, an input unit 204, an output unit 205, a communication unit 206, and an antenna 207.

The storage unit 201 is a memory such as a ROM, a RAM, and the like, and stores computer programs for performing various kinds of operation to be described later and various kinds of information such as communication parameters for wireless communication. ROM is an acronym for Read Only Memory. RAM is an acronym for Random Access Memory. Besides the memory such as a ROM, a RAM, and the like, a storage medium such as a flexible disk, a hard disk, an optical disc, a magneto-optical disk, a CD-ROM, a CD-R, a magnetic tape, a non-volatile memory card, a DVD, or the like may be used as the storage unit 201. The storage unit 201 may include a plurality of memories and the like.

The control unit 202 is configured as one or more processors, for example, a CPU, an MPU, or the like, and performs overall control on the communication apparatus 101 by running the computer programs stored in the storage unit 201. CPU is an acronym for Central Processing Unit. MPU is an acronym for Micro Processing Unit. The control unit 202 may be configured to perform overall control on the communication apparatus 101 through cooperative operation of the computer programs stored in the storage unit 201 and an OS (Operating System). The control unit 202 generates data and signals that are transmitted in communication with another communication apparatus. The control unit 202 may include a plurality of processors such as a multi-core processor, and may perform overall control on the communication apparatus 101 by means of the plurality of processors. The control unit 202 controls each hardware to perform predetermined processing such as wireless communication, image capturing, printing, projection, or the like.

The function unit 203 is hardware used for performing the predetermined processing by the communication apparatus 101. For example, based on the control by the control unit 202, the predetermined processing such as image capturing, printing, projection, or the like is performed.

The input unit 204 receives various kinds of operation from a user. The output unit 205 performs various kinds of outputting to the user via a monitor screen and speakers. The output by the output unit 205 may be display on the monitor screen, audio output by the speakers, vibration output, and the like. The input unit 204 and the output unit 205 may be embodied by a single module as in a touch panel. Each of the input unit 204 and the output unit 205 need not be configured integrally with the communication apparatus 101, and may be configured on a terminal different from the communication apparatus 101 such that inputting and outputting can be performed.

The communication unit 206 controls wireless communication conforming to the IEEE 802.11 standard. The communication unit 206 may control wireless communication conforming to any other IEEE 802.11 series standard, in addition to the IEEE 802.11 standard, or may control wired communication such as wired LAN. The communication unit 206 controls the antenna 207 to transmit and receive a wireless signal generated by the control unit 202 for wireless communication.

In a case where the communication apparatus 101 supports the NFC standard, the Bluetooth standard, or the like in addition to the IEEE 802.11 standard, the communication unit 206 may control wireless communication conforming to these communication standards. The communication apparatus 101, if capable of performing wireless communication conforming to a plurality of communication standards, may include each individual set of the communication unit 206 and the antenna 207 that corresponds to each of the communication standards. The communication apparatus 101 performs communication of data such as image data, document data, video data, and the like with the communication apparatuses 102 to 104 via the communication unit 206.

An example of the functional configuration of the communication apparatus 101, which is an AP in the present embodiment, is illustrated in FIG. 3. The same or similar configuration can also be adopted for the communication apparatuses 102 to 104, which are STAs. Though the AP 101 includes a single wireless LAN control unit 301 in this example, the number of wireless LAN control units is not limited to one; it may be two or more. The AP 101 further includes a frame generation unit 302, a frame analysis unit 303, a channel allocation unit 304, a UI control unit 305, a storage unit 306, and a wireless antenna 307.

The wireless LAN control unit 301 includes an antenna and a circuit for transmitting and receiving a wireless signal to and from another wireless LAN apparatus, and a program for controlling them. Being compliant with the IEEE 802.11 series standard, the wireless LAN control unit 301 performs wireless LAN communication control on the basis of a control frame generated by the frame generation unit 302.

The frame generation unit 302 generates a wireless communication frame (frame) that is to be transmitted by the wireless LAN control unit 301. Based on settings stored in the storage unit 306, restrictions may be imposed on the content of the frame generated by the frame generation unit 302. The content may be changed based on user settings from the UI control unit 305.

The frame analysis unit 303 interprets the frame received by the wireless LAN control unit 301, and reflects its content to the wireless LAN control unit 301.

The channel allocation unit 304 performs control for properly allocating a channel to be used for communication between the AP and an STA when an instruction for communication with the communication partner or communication with the STA is given. In accordance with the channel allocation determined here, for example, the AP 101 and the STA 102 communicate using the channel allocated by the channel allocation unit or using a sub-channel specified in the channel.

The UI control unit 305 includes hardware that relates to a non-illustrated user interface of the AP such as a touch panel or buttons, etc. for receiving operations to the AP by the user, and a program for controlling them. The UI control unit 305 may have a function of presenting information to the user, for example, display of characters, images, symbols, and the like, or audio output or the like.

The storage unit 306 is a storage device that can be configured using a ROM, a RAM, etc. storing programs to be run by the AP and storing data.

### First Embodiment

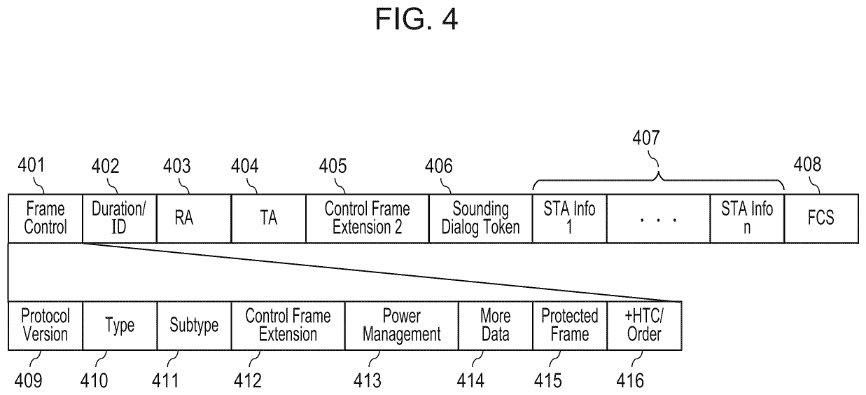

A first embodiment will now be described with reference to FIG. 4. In the present embodiment, an NDPA (Null Data Packet Announcement) frame is used as an example of a type of a control frame; however, the present invention is not limited thereto. An NDPA frame is a control frame that is transmitted by an AP to an STA for the purpose of notification in advance that an NDP (Null Data Packet) will be transmitted.

FIG. 4 illustrates a frame format of an NDPA frame that is an example of a control frame according to the present embodiment.

An NDPA frame according to the present embodiment is constructed of a Frame Control field 401, a Duration/ID field 402, an RA field 403, a TA field 404, a Control Frame Extension 2 field 405, a Sounding Dialog Token field 406, an STA Info field 407, and an FCS (Frame Check Sequence) field 408.

The Frame Control field 401 is constructed of a Protocol Version subfield 409, a Type subfield 410, a Subtype subfield 411, a Control Frame Extension subfield 412, a Power Management subfield 413, a More Data subfield 414, a Protected Frame subfield 415, and a +HTC/Order subfield 416.

The frame format according to the present embodiment is not limited to this example; it is sufficient as long as the MAC frame includes at least the Frame Control field 401 and the Control Frame Extension 2 field 405. It is sufficient as long as the Frame Control field 401 includes at least the Type subfield 410, the Subtype subfield 411, and the Control Frame Extension subfield 412. The Type subfield 410 is assigned two bits. In a

case where the Type subfield value is 0 (00), it indicates a management frame. In a case where the Type subfield value is 1 (01), it indicates a control frame. In a case where the Type subfield value is 2 (10), it indicates a data frame. In a case where the Type subfield value is 3 (11), it indicates an extension frame.

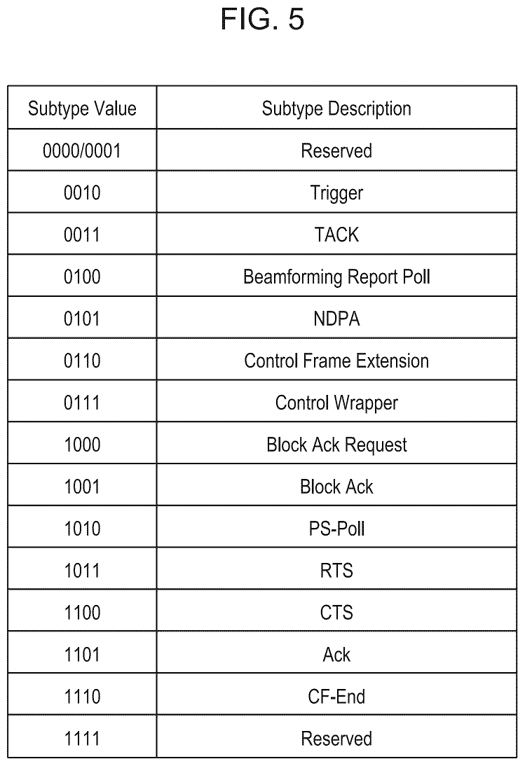

The Subtype subfield 411 is assigned four bits. In a case where the type of the MAC frame is a control frame in the present embodiment (that is, in a case where the Type subfield value is 1), values that can be set in the Subtype subfield 411 are defined as illustrated in FIG. 5.

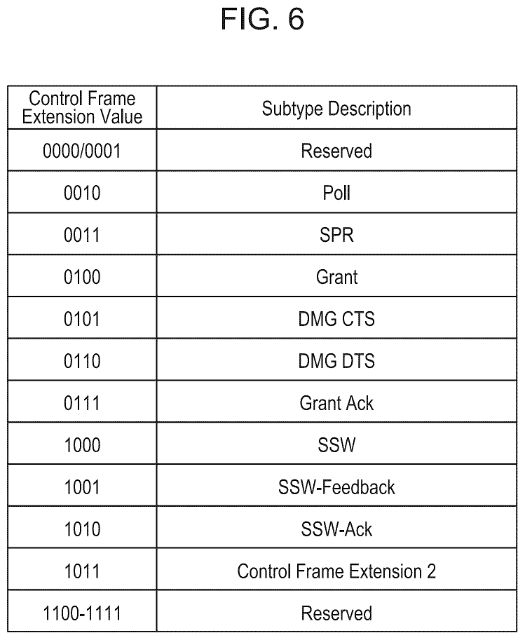

When 6 (0110) is set as the value of the Subtype subfield 411, it indicates that the Control Frame Extension subfield 412 exists immediately behind the Subtype subfield 411. If the Control Frame Extension subfield 412 exists, the type of a control frame is identified by information in the Control Frame Extension subfield 412. The Control Frame Extension subfield 412 is assigned four bits, and up to sixteen types of a control frame are identifiable (FIG. 6).

In the present embodiment, 11 (1011) is set as the value of the Control Frame Extension subfield 412. In this case, it indicates that the Control Frame Extension 2 field 405 is located behind the Control Frame Extension subfield 412. The Control Frame Extension subfield value indicating that the Control Frame Extension 2 field 405 exists may be a value other than 11 (1011). For example, this value may be 0 (0000), 1 (0001), 12 (1100), 13 (1101), 14 (1110), or 15 (1111).

As described above, apart from the Control Frame Extension subfield 412, the Control Frame Extension 2 field 405 that is assigned four bits is used. This makes it possible to increase identifiable types of a control frame up to 16. The bit length of the Control Frame Extension subfield 412 may be a value other than four.

### Second Embodiment

In the first embodiment, a case where the Control Frame Extension 2 field 405 is designated by setting a particular value in the Control Frame Extension subfield 412 has been described.

The present embodiment is different from the first embodiment in that a Control Frame Extension 2 subfield is provided inside the Frame Control field 401.

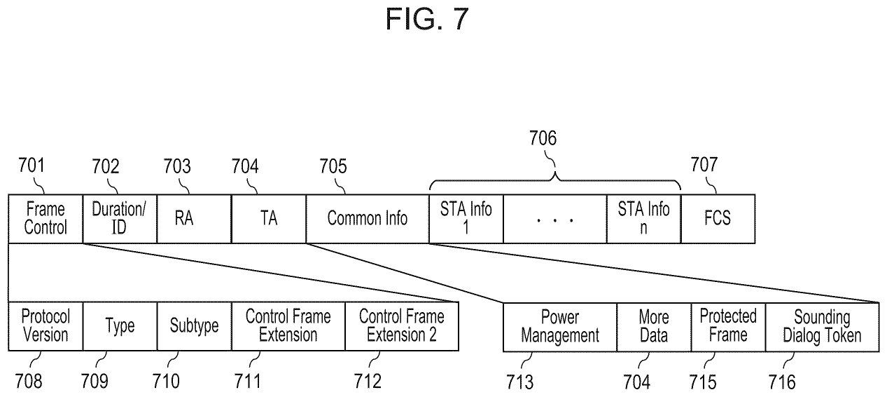

The present embodiment will now be described with reference to FIG. 7. An NDPA frame according to the present embodiment is constructed of a Frame Control field 701, a Duration/ID field 702, an RA field 703, a TA field 704, a Common Info field 705, an STA Info field 706, and an FCS field 707.

The Frame Control field 701 is constructed of a Protocol Version subfield 708, a Type subfield 709, a Subtype subfield 710, a Control Frame Extension subfield 711, and a Control Frame Extension 2 subfield 712.

The Common Info field 705 is constructed of a Power Management subfield 713, a More Data subfield 714, a Protected Frame subfield 715, and a Sounding Dialog Token subfield 716. With regard to the subfields which the Common Info field is constructed of, it is sufficient as long as at least information that represents each subfield is included in the frame, and the configuration of the frame is not limited to this example. The frame format according to the present embodiment is not limited to this example; it is sufficient as long as the MAC frame includes at least the Frame Control field 701. It is sufficient as long as the Frame Control field 701 includes at least the Type subfield 709, the Subtype subfield 710, the Control Frame Extension subfield 711, and the Control Frame Extension 2 subfield 712.

The values that can be set for the Type subfield 709, the Subtype subfield 710, and the Control Frame Extension subfield 711 in the Frame Control field 701 are the same as those of the first embodiment. Their respective values are 1 (01), 6 (0110), and 11 (1011).

In the present embodiment, the Control Frame Extension 2 subfield 712 is expressed by four bits at the maximum, and up to sixteen types of a control frame are identifiable.

In the present embodiment, a part of the subfields that was included in the Frame Control field 701 in the first embodiment has been moved to the Common Info field 705. However, the bit length of the Control Frame Extension 2 subfield 712 may be three bits or less. In that case, a part of the subfields shown in the Common Info field 705 may be included in the Frame Control field 701. That is, it is sufficient to determine the subfields included in the Frame Control field 701 such that the bit length of the Frame Control field 701 is sixteen bits.

### Third Embodiment

The present embodiment is different from each of the foregoing embodiments in that the Subtype subfield is used for indicating the existence of the Control Frame Extension 2 field.

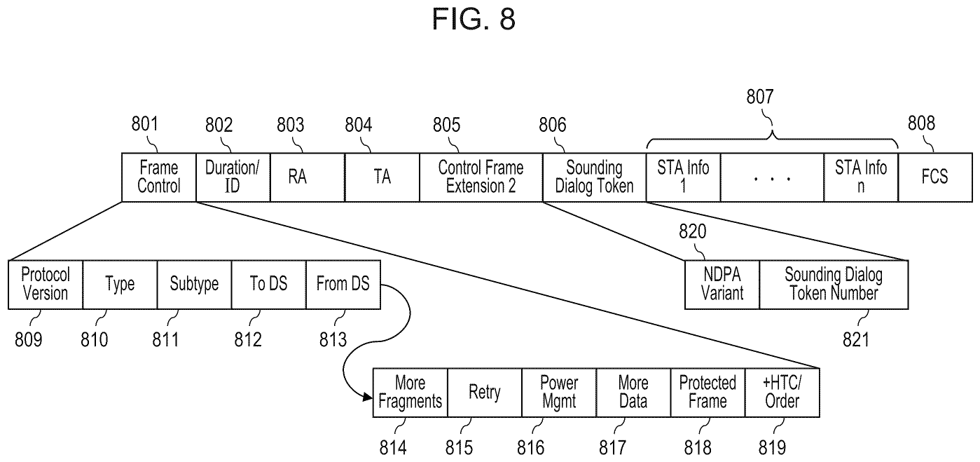

The present embodiment will now be described with reference to FIG. 8. Fields 801 to 808 that constitute a frame according to the present embodiment are the same as the fields 401 to 408 according to the first embodiment, and the difference lies only in the configuration of subfields included in the Frame Control field 801.

In the present embodiment, the Frame Control field 801 is constructed of a Protocol Version subfield 809, a Type subfield 810, a Subtype subfield 811, a To DS subfield 812, a From DS subfield 813, a More Fragments subfield 814, a Retry subfield 815, a Power Management subfield 816, a More Data subfield 817, a Protected Frame subfield 818, and a +HTC/Order subfield 819.

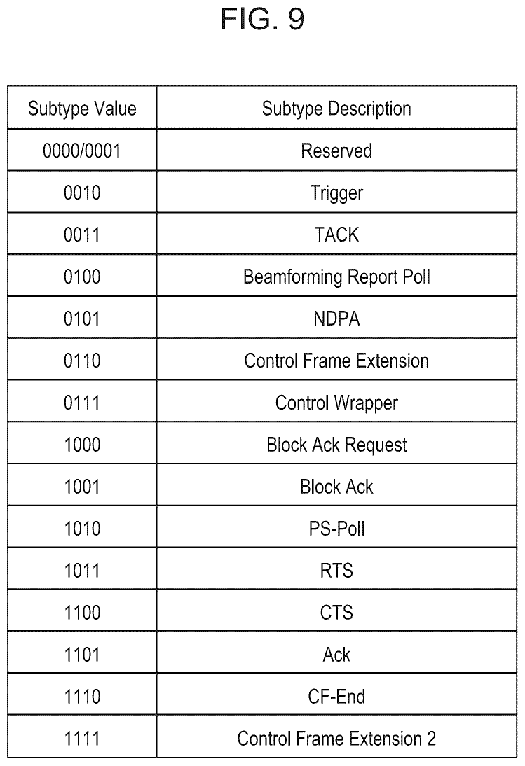

The values of the Subtype subfield according to the present embodiment are defined as illustrated in FIG. 9 instead of FIG. 5. When 15 (1111) is set as the value of the Subtype subfield, it indicates that the Control Frame Extension 2 field 805 exists. This value of the Subtype subfield 811 is not limited to 15 (1111) and may be 0 (0000) or 1 (0001); any value may be adopted as long as it is not 6 (0110), which indicates the existence of the Control Frame Extension subfield described earlier in the first embodiment.

In the present embodiment, the bit length of the Control Frame Extension 2 field 805 is assumed to be four; however, any other number of bits may be assigned thereto. For example, if two bits, four types of a control frame are identifiable. If three bits, eight types of a control frame are identifiable.

### Fourth Embodiment

In the second embodiment, an example in which the Control Frame Extension 2 subfield is included in the Frame Control field has been described.

In the third embodiment, an example in which the Subtype subfield is used for indicating the existence of the Control Frame Extension 2 field has been described.

The present embodiment is the same as the second embodiment in that the Control Frame Extension 2 subfield is included in the Frame Control field. However, the present embodiment is different from the second embodiment in that the Control Frame Extension 2 subfield is designated using the Subtype subfield. Moreover, the present embodiment is different from the third embodiment in that the Control Frame Extension 2 subfield is included in the Frame Control field. However, the present embodiment is the same as the third embodiment in that the Control Frame Extension 2 subfield is designated using the Subtype subfield.

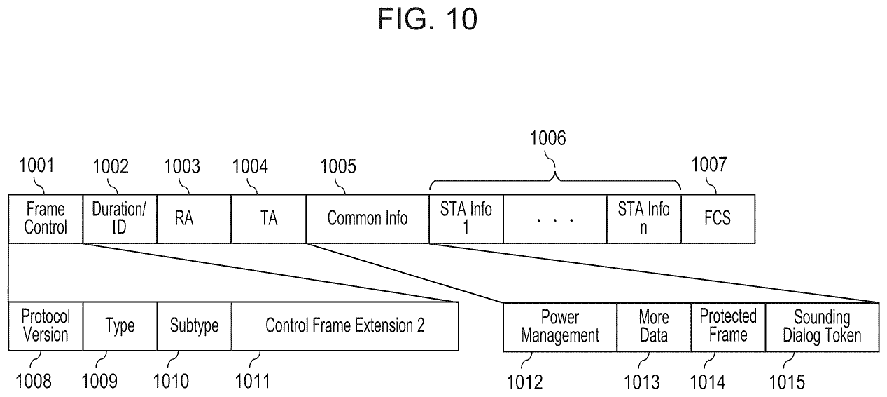

The present embodiment will now be described with reference to FIG. 10. In the present embodiment, a Frame Control field 1001 is constructed of a Protocol Version subfield 1008, a Type subfield 1009, a Subtype subfield 1010, and a Control Frame Extension 2 subfield 1011.

In the present embodiment, the value of the Subtype subfield is 15 (1111), which indicates that the Control Frame Extension 2 subfield 1011 lies immediately behind it. The value of the Subtype subfield may be 0 (0000) or 1 (0001), and it is sufficient as long as the existence of the Control Frame Extension 2 subfield 1011 is indicated by a value that is not 6 (0110).

In the present embodiment, eight bits are assigned to the Control Frame Extension 2 subfield 1011, and up to 256 types of a control frame are identifiable. In a case where the bit length is seven bits or less, a part of the subfields included in a Common Info field 1005 may be included in the Frame Control field 1001. It is sufficient to determine the subfields included in the Frame Control field 1001 such that the bit length of the Frame Control field 1001 is sixteen bits.

### Other Embodiments

The name of the Control Frame Extension 2 field 405 having been described above is a non-limiting example, and any name may be given thereto as long as it is distinguishable from the Control Frame Extension subfield 412.

Though the foregoing description has been given while making a distinction between a field and a subfield included in the field, they may be collectively called a field. For example, a Type subfield may be called a Type field. A Subtype subfield may be called a Subtype field. A Control Frame Extension subfield may be called a Control Frame Extension field.

The present disclosure can be implemented also in a case where the communication apparatus 101 to 104 has an image-capturing function. In a case where the communication apparatus 101 to 104 has an image-capturing function, the communication apparatus 101 to 104 may communicate, via the communication unit 206, image data generated by the image-capturing function. In that case, the communication apparatus 101 to 104 can communicate, via the communication unit 206, by using a MAC frame according to the present disclosure, the image data generated by the image-capturing function.

The present disclosure can be implemented also in a case where the communication apparatus 101 to 104 has a printing function. In a case where the communication apparatus 101 to 104 has a printing function, the communication apparatus 101 to 104 may communicate, via the communication unit 206, image data that is to be used for printing. In that case, the communication apparatus 101 to 104 can communicate, via the communication unit 206, by using a MAC frame according to the present disclosure, the image data that is to be used for printing. Then, the communication apparatus 101 to 104 is capable of performing printing by the printing function by using the received image data.

The present invention can be implemented also by supplying, to a system or an apparatus via a network or by means of a storage medium, a program that realizes one or more functions of the foregoing embodiments, and by causing one or more processors in the computer of the system or the apparatus to read out and run the program. The present invention can be implemented also by means of circuitry (for example, ASIC) that realizes the one or more functions.

The present disclosure makes it possible to communicate a MAC frame well in a wireless communication apparatus conforming to the IEEE 802.11 standard.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A wireless communication apparatus, comprising:
at least one memory that stores instructions; and
at least one processor that executes the instructions stored in the at least one memory to cause the wireless communication to perform:
communicating a MAC frame conforming to an IEEE 802.11 standard,
wherein
the MAC frame includes a Frame Control field,
the Frame Control field includes a Type field indicating a type of the MAC frame,
the Frame Control field further includes a Subtype field in a case where a value indicating that the type of the MAC frame is a control frame is set in the Type field,
the Frame Control field further includes a Control Frame Extension field in a case where a value indicating existence of the Control Frame Extension field is set in the Subtype field, and
the MAC frame further includes a predetermined field in a case where a value indicating existence of the predetermined field is set in a first field in the Frame Control field, the predetermined field being a field in which a value indicating a type of the control frame is settable and which is different both from the Subtype field and from the Control Frame Extension field.

2. The wireless communication apparatus according to claim 1 wherein, the first field is the Control Frame Extension field.

3. The wireless communication apparatus according to claim 1, wherein the first field is the Subtype field.

4. The wireless communication apparatus according to claim 1, wherein the communicating includes at least one of transmitting or receiving the MAC frame conforming to the IEEE 802.11 standard.

5. The wireless communication apparatus according to claim 1, wherein the predetermined field is located behind the Frame Control field.

6. The wireless communication apparatus according to claim 1, wherein the predetermined field is included in the Frame Control field.

7. The wireless communication apparatus according to claim 1, the at least one processor further executing the instructions stored in the at least one memory to cause the wireless communication to perform:
connecting with an access point configured to establish a network; and
communicating, based on the MAC frame, with the access point.

8. The wireless communication apparatus according to claim 1, the at least one processor further executing the instructions stored in the at least one memory to cause the wireless communication to perform:
establishing a network; and
communicating, based on the MAC frame, with a station participating in the network.

9. The wireless communication apparatus according to claim 7, further comprising:
a printer, wherein
the at least one processor further executes the instructions stored in the at least one memory to cause the wireless communication to perform:
communicating image data to be used for printing by the printer.

10. The wireless communication apparatus according to claim 7, further comprising:
an image capturing unit, wherein the at least one processor further executing the instructions stored in the at least one memory to cause the wireless communication to perform:
communicating image data generated by the image capturing unit.

11. A wireless communication method, comprising:
communicating a MAC frame conforming to an IEEE 802.11 standard, wherein
the MAC frame includes a Frame Control field,
the Frame Control field includes a Type field indicating a type of the MAC frame,
the Frame Control field further includes a Subtype field in a case where a value indicating that the type of the MAC frame is a control frame is set in the Type field,
the Frame Control field further includes a Control Frame Extension field in a case where a value indicating existence of the Control Frame Extension field is set in the Subtype field, and
the MAC frame further includes a predetermined field in a case where a value indicating existence of the predetermined field is set in a first field in the Frame Control filed, the predetermined field being a field in which a value indicating a type of the control frame is settable and which is different both from the Subtype field and from the Control Frame Extension field.

12. The wireless communication method according to claim 11, wherein the first field is the Control Frame Extension field.

13. The wireless communication method according to claim 11, wherein the first field is the subtype field.

14. The wireless communication method according to claim 11, wherein the communicating includes at least one of transmitting or receiving the MAC frame conforming to the IEEE 802.11 standard.

15. A non-transitory computer readable storage medium storing a program causing a computer to operate as each means of the wireless communication apparatus according to claim 1.
